(19) United States
(12) Patent Application Publication
(10) Pub. No.: US 2010/0018486 A1
(43) Pub. Date: Jan. 28, 2010

(54) Cathode energy fuel-saving device

(76) Inventors: Hung-Tao Liu, Taipei City (TW); Jia-Min Liu, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/219,412

(22) Filed: Jul. 22, 2008

(51) Int. Cl. F02M 25/00; C10L 10/00

(52) U.S. Cl. 123/1 A; 123/198 R

(57) ABSTRACT

A cathode energy fuel-saving device including a strap body having at least one cathode energy mineral-containing band section containing cathode energy mineral powders. The strap body can be wound and tightened around a fuel inlet pipe or intake pipe of an internal combustion engines. The cathode energy mineral-containing band section of the strap body is able to enhance activity and combustibility of the fuel and air entering the fuel inlet pipe and intake pipe so as to promote combustion efficiency of the internal combustion engine and reduce fuel consumption. Two ends of the strap body are respectively provided with hooked section and latch member, which can be easily latched with each other to tighten the strap body around the fuel inlet pipe or intake pipe.

### BACKGROUND OF THE INVENTION

The present invention is related to a cathode energy fuel-saving device, and more particularly to a strap body having at least one cathode energy mineral-containing band section containing cathode energy mineral powders. Two ends of the strap body are respectively provided with hooked section and latch member, which can be quickly and easily latched with each other to tighten the strap body around a fuel inlet pipe or intake pipe of an internal combustion engine or unlatched from each other to remove the strap body from the fuel inlet pipe or intake pipe.

Internal combustion engines are widely applied to various fields nowadays, especially to vehicles and some industries. An internal combustion engine provides power mainly by means of combustion of petrochemical fuel. However, the petrochemical energy source of the earth has been continuously greatly consumed and the whole world now faces energy crisis. Recently, global oil price has stepwise sharply risen and all major advanced countries in the world have invested huge money and labor to develop alternative energies and energy-saving devices. In recent years, various fuel-saving devices for internal combustion engines have sprung up and come into market.

### SUMMARY OF THE INVENTION

It is therefore a primary object of the present invention to provide a cathode energy fuel-saving device for atomizing and ionizing the fuel or air entering the fuel inlet pipe or intake pipe and enhancing activity or oxygen-carrying capability of the molecules of the fuel or air. Accordingly, after the fuel is mixed with the air, the fuel with the air enters the internal combustion engine, the chain combustion of the fuel is speeded to promote combustion efficiency and reduce exhaust emission and accumulated carbon.

According to the above object, the cathode energy fuel-saving device of the present invention includes a strap body having at least one cathode energy mineral-containing band section containing cathode energy mineral powders. The strap body can be directly wound and tightened around a fuel inlet pipe or intake pipe of an internal combustion engines. Under such circumstance, the cathode energy mineral-containing band section of the strap body encloses the fuel inlet pipe or intake pipe to provide cathode energy-transformed negative ionizing effect for the fuel or air flowing through the fuel inlet pipe or intake pipe. Two ends of the strap body are respectively provided with at least one hooked section and at least one latch member corresponding to the hooked section. The latch member and the hooked section can be easily adjustably latched with each other to tighten the strap body around the fuel inlet pipe or intake pipe.

Alternatively, multiple cathode energy mineral-containing band sections are arranged on the strap body at specific equal intervals. Accordingly, the cathode energy mineral-containing band sections are wound around the pipe in a specific distribution pattern to provide enhanced energy. Accordingly, the present invention is able to quantitatively controllably promote the combustion efficiency of the fuel.

The latch member is multistage adjustably latched with the hooked section to define an inner diameter of the strap body. Therefore, the inner diameter of the strap body is variable with the diameter of the fuel inlet pipes or intake pipe to adapt the strap body to different fuel inlet pipes or intake pipes.

The present invention can be best understood through the following description and accompanying drawings wherein:

### BRIEF DESCRIPTION OF THE DRAWINGS

FIG. 1 is a perspective view of a first embodiment of the fuel-saving device of the present invention;

FIG. 2 is a perspective view showing that three fuel-saving devices according to FIG. 1 are applied to a fuel inlet pipe or intake pipe;

FIG. 3 is a perspective view of a second embodiment of the fuel-saving device of the present invention;

FIG. 4 is a perspective view showing the fuel-saving devices according to FIG. 3 is applied to a fuel inlet pipe or intake pipe;

FIG. 5 is a perspective view of a third embodiment of the fuel-saving device of the present invention;

FIG. 6 is a perspective view of a fourth embodiment of the fuel-saving device of the present invention; and

FIG. 7 is a perspective view showing the fuel-saving devices according to FIG. 6 is applied to a fuel inlet pipe or intake pipe.

### DETAILED DESCRIPTION OF THE PREFERRED EMBODIMENTS

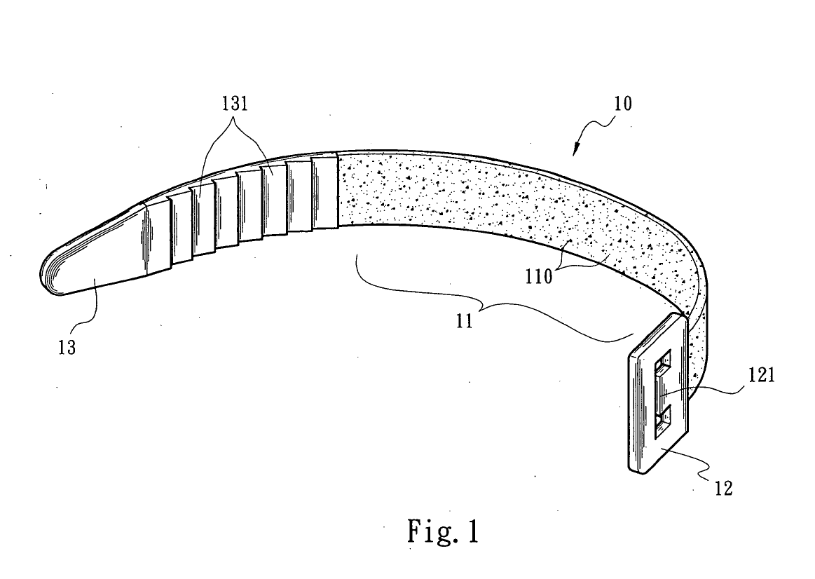

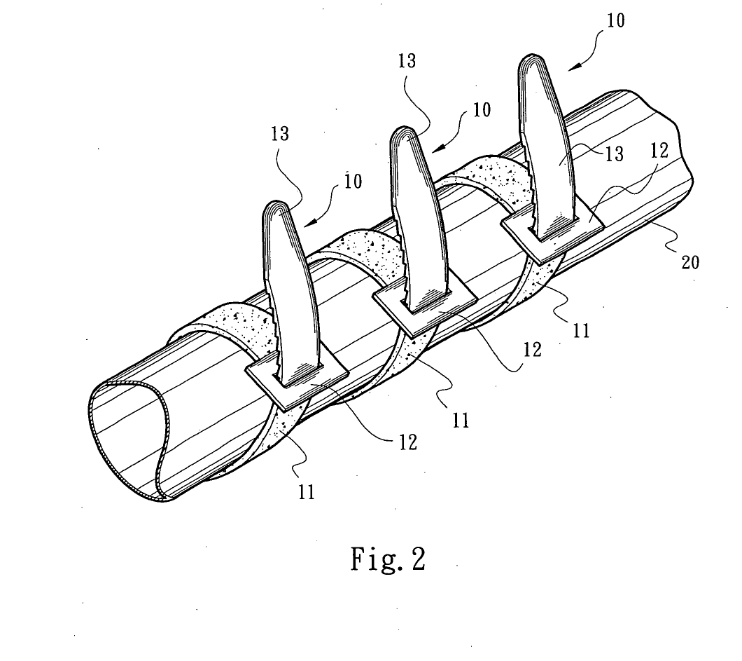

Please refer to FIGS. 1 and 2. According to a first embodiment, the cathode energy fuel-saving device of the present invention includes a strap body 10 having at least one cathode energy mineral-containing band section 11 containing cathode energy mineral powders 110. The cathode energy mineral powders 110 can be previously mixed with the material of the strap body 10 to form a mixture. The mixture is then integrally molded to form the cathode energy band section 11. Alternatively, the cathode energy mineral powders 110 can be mixed with an adhesive material to form a paint. After the strap body 10 is molded, the paint is painted on a surface of the strap body 10 to form a coating as the cathode energy mineral-containing band section. The strap body 10 has a sufficient length, whereby the strap body 10 can be wound around a fuel inlet pipe or intake pipe 20 of an internal combustion engine. A first end of the strap body 10 is formed with a hooked section 13 having hook structures 131, while a second end of the strap body 10 is provided with a latch member 12 having a latch structure 121 corresponding to the hook structures 131. The latch structure 121 is multistage adjustably latchable with one of the hook structures 131 to tighten the strap body 10 around the fuel inlet pipe or intake pipe 20. In this embodiment, the hooked section 13 is a saw-toothed section having multiple saw teeth as the hook structures 131, while the latch member 12 is a buckle having a buckle tongue as the latch structure 121.

As shown in FIG. 2, at least one strap body 10 is directly wound around the fuel inlet pipe or intake pipe 20 and the buckle tongue 121 is adjustably engaged with one of the teeth of the saw-toothed surface 131 to tighten the strap body 10 around the pipe 20 without slippage. As necessary, multiple strap bodies 10 can be wound and tightened around one single pipe 20 to achieve enhanced effect.

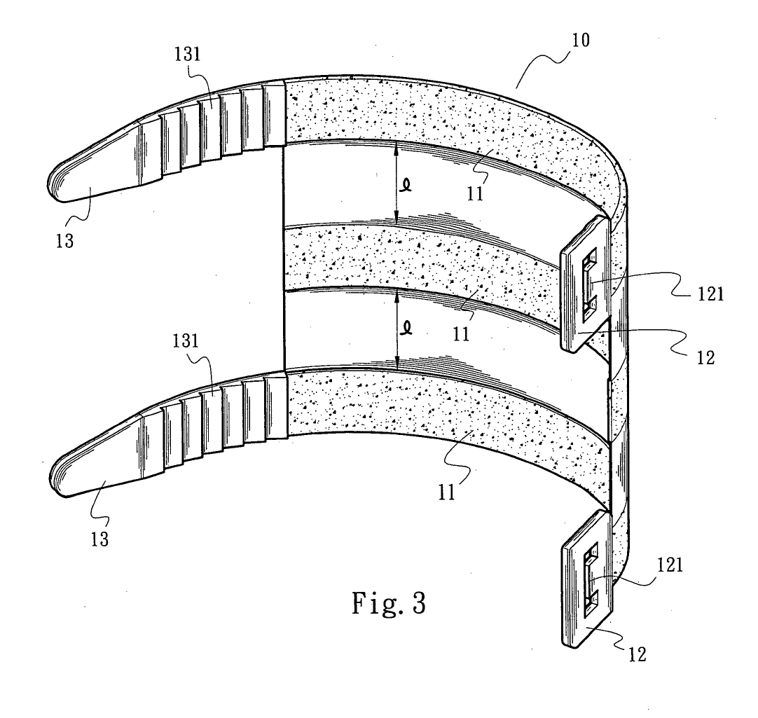

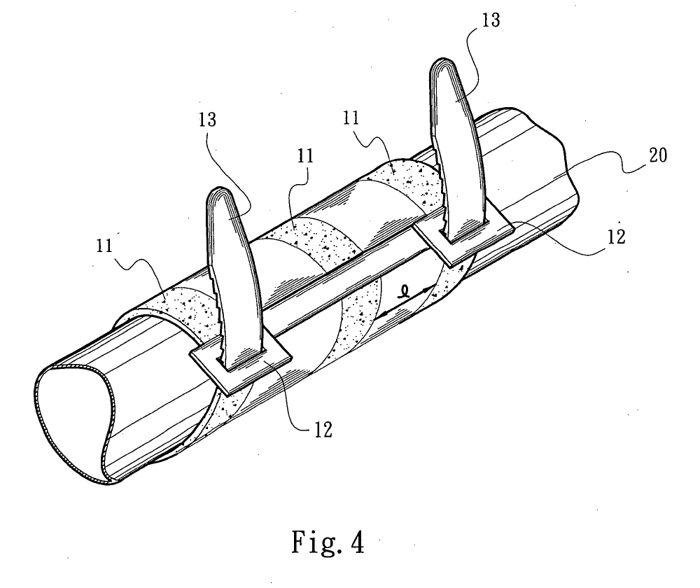

Please now refer to FIGS. 3 and 4, which show a second embodiment of the present invention. In the second embodiment, the strap body 10 is a widened strap having a sufficient width. The strap body 10 includes multiple cathode energy mineral-containing band sections 11 extending in a winding direction of the strap body 10. The cathode energy mineral-containing band sections 11 are arranged on the strap body 10 at certain intervals l (within a range of about 4˜6 cm). A first end of the strap body 10 is formed with several hooked section 13 each having hook structures 131, while a second end of the strap body 10 is provided with several latch members 12 each having a latch structure 121. The latch structures 121 is multistage adjustably latchable with the hook structures 131 to easily accurately fix the cathode energy mineral-containing band sections 11 of the strap body 10 around the fuel inlet pipe or intake pipe 20 at one time (as shown in FIG. 4). Therefore, it is unnecessary to troublesomely repeatedly measure the intervals between the cathode energy mineral-containing band sections 11.

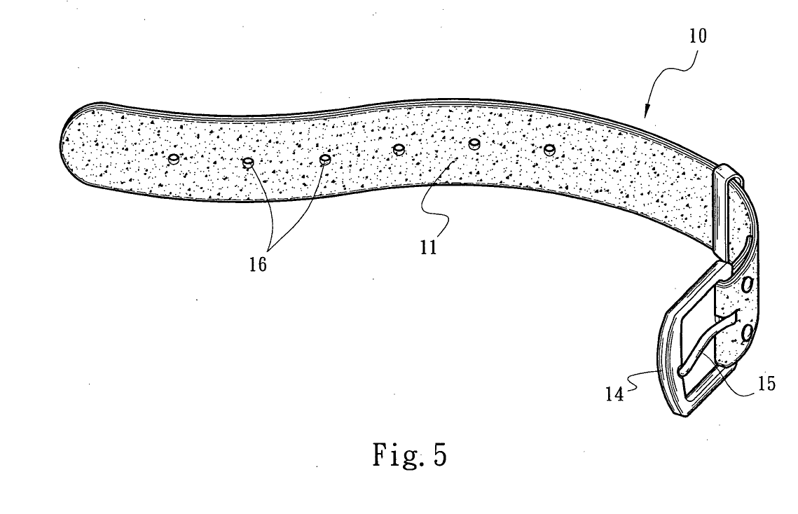

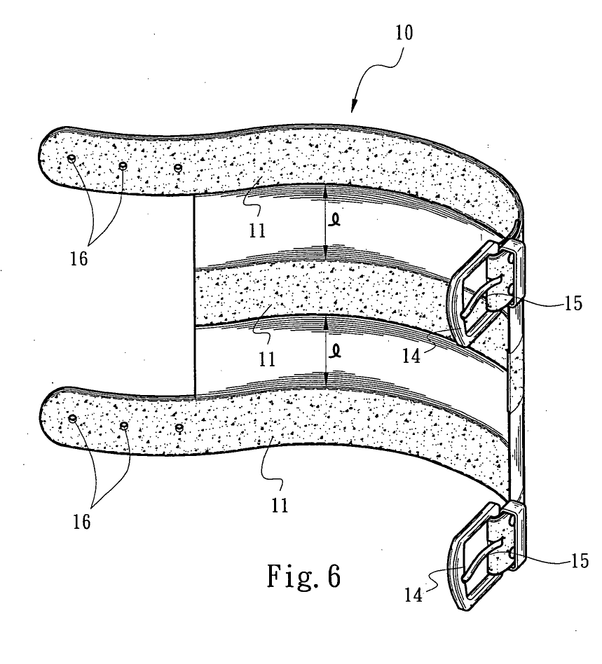

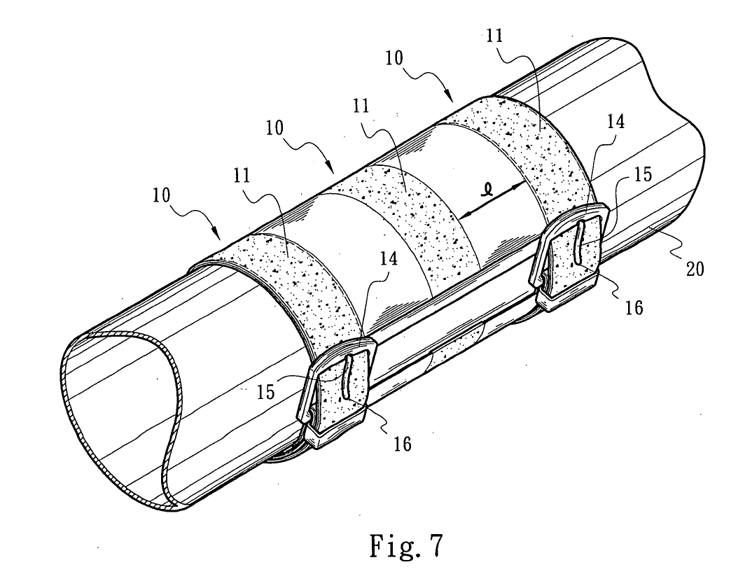

FIG. 5 shows a third embodiment of the present invention, in which the strap body 10 has the form of a belt. One end of the strap body 10 is provided with a buckle having a buckle ring 14 and a buckle tongue 15. A string of tongue holes 16 are formed on the other end of the strap body 10. The other end of the strap body 10 can be passed through the buckle ring 14 and the buckle tongue 15 can be inserted through one of the tongue holes 16 to define an inner diameter of the strap body 10. The buckle tongue 15 can be alternatively inserted through any other tongue hole 16 to quickly adjust the inner diameter of the strap body 10. Accordingly, the strap body 10 is conveniently adaptable to different fuel inlet pipes or intake pipes 20. FIGS. 6 and 7 show a fourth embodiment of the present invention, in which strap body 10 is a widened strap with multiple cathode energy mineral-containing band sections 11.

According to the above arrangement, the fuel-saving device of the present invention is mountable on the fuel inlet pipes or intake pipes 20 of various internal combustion engines (such as vehicle engines). The cathode energy mineral-containing band sections 11 of the strap body 10 are able to atomize the fluid (fuel or air) in the pipe and activate (energize) the molecules of the fluid. Accordingly, more complete combustion of the fuel entering the internal combustion engine can be achieved to promote and smoothen operation power. As a result, the ratio of fuel loss can be lowered and the exhaust emission can be reduced to save energy and fuel.

The above embodiments are only used to illustrate the present invention, not intended to limit the scope thereof. Many modifications of the above embodiments can be made without departing from the spirit of the present invention.

What is claimed is:

1. A cathode energy fuel-saving device comprising a strap body having at least one cathode energy mineral-containing band section containing cathode energy mineral powders, at least a first end of the strap body being formed with a hooked section, while a second end of the strap body being provided with a latch member corresponding to the hooked section.

2. The cathode energy fuel-saving device as claimed in claim 1, wherein the cathode energy mineral powders are previously mixed with a material of the strap body to form a mixture, the mixture being then integrally molded to form the cathode energy band section.

3. The cathode energy fuel-saving device as claimed in claim 1, wherein a paint made of the cathode energy mineral powders is painted on a surface of the strap body to form a coating as the cathode energy mineral-containing band section.

4. The cathode energy fuel-saving device as claimed in claim 1, wherein multiple cathode energy mineral-containing band sections are arranged on the strap body at equal intervals.

5. The cathode energy fuel-saving device as claimed in claim 2, wherein multiple cathode energy mineral-containing band sections are arranged on the strap body at equal intervals.

6. The cathode energy fuel-saving device as claimed in claim 3, wherein multiple cathode energy mineral-containing band sections are arranged on the strap body at equal intervals.

7. The cathode energy fuel-saving device as claimed in claim 1, wherein the hooked section has hook structures, while the latch member has a latch structure corresponding to the hook structures.

8. The cathode energy fuel-saving device as claimed in claim 2, wherein the hooked section has hook structures, while the latch member has a latch structure corresponding to the hook structures.

9. The cathode energy fuel-saving device as claimed in claim 3, wherein the hooked section has hook structures, while the latch member has a latch structure corresponding to the hook structures.

10. The cathode energy fuel-saving device as claimed in claim 4, wherein the hooked section has hook structures, while the latch member has a latch structure corresponding to the hook structures.

11. The cathode energy fuel-saving device as claimed in claim 7, wherein the latch structure is multistage adjustably latchable with one of the hook structures.

12. The cathode energy fuel-saving device as claimed in claim 8, wherein the latch structure is multistage adjustably latchable with one of the hook structures.

13. The cathode energy fuel-saving device as claimed in claim 9, wherein the latch structure is multistage adjustably latchable with one of the hook structures.

14. The cathode energy fuel-saving device as claimed in claim 10, wherein the latch structure is multistage adjustably latchable with one of the hook structures.

15. The cathode energy fuel-saving device as claimed in claim 1, wherein the strap body has the form of a belt.

16. The cathode energy fuel-saving device as claimed in claim 2, wherein the strap body has the form of a belt.

17. The cathode energy fuel-saving device as claimed in claim 3, wherein the strap body has the form of a belt.

18. The cathode energy fuel-saving device as claimed in claim 4, wherein the strap body has the form of a belt.

19. The cathode energy fuel-saving device as claimed in claim 1, wherein one end of the strap body is provided with a buckle having a buckle ring and a buckle tongue, a string of tongue holes being formed on the other end of the strap body corresponding to the buckle tongue.

20. The cathode energy fuel-saving device as claimed in claim 2, wherein one end of the strap body is provided with a buckle having a buckle ring and a buckle tongue, a string of tongue holes being formed on the other end of the strap body corresponding to the buckle tongue.

21. The cathode energy fuel-saving device as claimed in claim 3, wherein one end of the strap body is provided with a buckle having a buckle ring and a buckle tongue, a string of tongue holes being formed on the other end of the strap body corresponding to the buckle tongue.

22. The cathode energy fuel-saving device as claimed in claim 4, wherein one end of the strap body is provided with a buckle having a buckle ring and a buckle tongue, a string of tongue holes being formed on the other end of the strap body corresponding to the buckle tongue.
